(19) United States
(12) Patent Application Publication
(10) Pub. No.: US 2023/0137150 A1
(43) Pub. Date: May 4, 2023

(54) DETERMINING HYDROCARBON WELL ROYALTY VALUATIONS

(71) Applicant: Enversus, Inc., Austin, TX (US)

(72) Inventors: Phillip Dunning, Austin, TX (US); Faber Wilcox, Austin, TX (US); Stephen Masters, Austin, TX (US)

(21) Appl. No.: 17/515,091

(22) Filed: Oct. 29, 2021

(51) Int. Cl. G06Q 40/06; G06Q 30/02; G06Q 50/02; G06K 9/00

(52) U.S. Cl. CPC G06Q 40/06; G06K 9/00456; G06Q 30/0278; G06Q 50/02

(57) ABSTRACT

Techniques for determining a hydrocarbon well royalty valuation include identifying a plurality of identifiers from a financial instrument associated with an ownership interest in a hydrocarbon production well, the plurality of identifiers comprising a payor identifier and an owner identifier; searching a database with the owner identifier to determine at least one additional payor identifier associated with the owner identifier; determining at least one additional financial instrument associated with the additional payor identifier; determining at least one additional hydrocarbon production well associated with the additional financial instrument; determining a financial valuation of the hydrocarbon production well and the at least one additional hydrocarbon production well; and generating data that comprises a representation of the determined financial valuation for presentation on a graphical user interface (GUI).

### TECHNICAL FIELD

This document relates to systems and methods for determining hydrocarbon well royalty valuations.

### BACKGROUND

Minerals and royalties that are paid for the production of such minerals (such as oil or gas or both) are valuable assets. However, owners of royalty interests often do not know with certainty the exact number of hydrocarbon wells, or exact identification of hydrocarbon wells, from which their royalties arise. Such uncertainty can lead to uncertainties in payments being provided to the correct entity (or at all).

### SUMMARY

In an example implementation, a computer-implemented method performed with a computing system that comprises one or more hardware processors includes identifying, with the one or more hardware processors, a plurality of identifiers from a financial instrument associated with an ownership interest in a hydrocarbon production well, the plurality of identifiers comprising a payor identifier and an owner identifier; searching, with the one or more hardware processors, a database with the owner identifier to determine at least one additional payor identifier associated with the owner identifier; determining, with the one or more hardware processors, at least one additional financial instrument associated with the additional payor identifier; determining, with the one or more hardware processors, at least one additional hydrocarbon production well associated with the additional financial instrument; determining, with the one or more hardware processors, a financial valuation of the hydrocarbon production well and the at least one additional hydrocarbon production well; and generating, with the one or more hardware processors, data that comprises a representation of the determined financial valuation for presentation on a graphical user interface (GUI).

In an aspect combinable with the example implementation, determining the additional hydrocarbon production well associated with the additional financial instruments comprises determining, with the one or more hardware processors, at least one property identifier associated with the additional financial instruments; determining, with the one or more hardware processors, at least one hydrocarbon production well identifier associated with the at least one property identifier; and determining, with the one or more hardware processors, the at least one additional hydrocarbon production well from the determined hydrocarbon production well identifier.

In another aspect combinable with any of the previous aspects, the at least one property identifier comprises a hydrocarbon lease identifier, and the at least one hydrocarbon production well identifier comprises an API number.

Another aspect combinable with any of the previous aspects further includes determining, with the one or more hardware processors, a real property boundary associated with the at least one property identifier; determining, with the one or more hardware processors, at least one real property parcel that is adjacent the real property boundary; and determining, with the one or more hardware processors, at least one other hydrocarbon production well located on the real property parcel.

Another aspect combinable with any of the previous aspects further includes determining, with the one or more hardware processors, that the at least one other hydrocarbon production well located on the real property parcel is unassociated with the owner identifier; determining, with the one or more hardware processors, a financial valuation of the other hydrocarbon production well; and generating, with the one or more hardware processors, additional data that comprises a representation of the determined financial valuation for the other hydrocarbon production well for presentation on the GUI.

In another aspect combinable with any of the previous aspects, the additional data further comprises at least one of a hydrocarbon production well identifier for the other hydrocarbon production well; or an owner identifier for the other hydrocarbon production well.

In another aspect combinable with any of the previous aspects, the financial instrument comprises a royalty payment check.

In another aspect combinable with any of the previous aspects, the plurality of identifiers further comprise a check number and a check amount.

In another aspect combinable with any of the previous aspects, the owner identifier comprises a name or number associated with an owner of the ownership interest in the hydrocarbon production well.

In another aspect combinable with any of the previous aspects, identifying the plurality of identifiers from the financial instrument associated with the ownership interest in the hydrocarbon production well comprises reading, with the one or more hardware processors, an image of the financial instrument; and determining, with the one or more hardware processors, the plurality of identifiers from the image.

In another aspect combinable with any of the previous aspects, the image comprises a scanned image.

The general implementation and example aspects may also be realized in a computing system and computer-readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

One, some, or all of the implementations according to the present disclosure may include one or more of the following features. For example, implementations according to the present disclosure may automate a royalty on-boarding process to create greater efficiencies and utilize less computing resources. As another example, implementations according to the present disclosure may create a one-to-many relationship structure that ties royalty owners to independent and unknown payors. As another example, implementations according to the present disclosure may create a buffer zone around an asset of a royalty owner to generate future royalty purchases by the owner.

The details of one or more embodiments are set forth in the accompanying drawings and the description below. Other features, objects, and advantages will be apparent from the description and drawings, and from the claims.

### DESCRIPTION OF DRAWINGS

FIG. 1 illustrates an example distributed network architecture that includes one or more client devices and one or more server devices for determining hydrocarbon well royalty valuations according to the present disclosure.

FIGS. 2A-2B illustrate flowcharts that show an example implementation of a method for determining hydrocarbon well royalty valuations according to the present disclosure.

FIGS. 3A-3C illustrate example graphical user interface (GUI) windows presented to a user during or subsequent to a method for determining hydrocarbon well royalty valuations according to the present disclosure.

FIG. 4 is a schematic diagram of all or a portion of a computing system that can be used for the operations described in association with any of the computer-implemented processes described herein.

### DETAILED DESCRIPTION

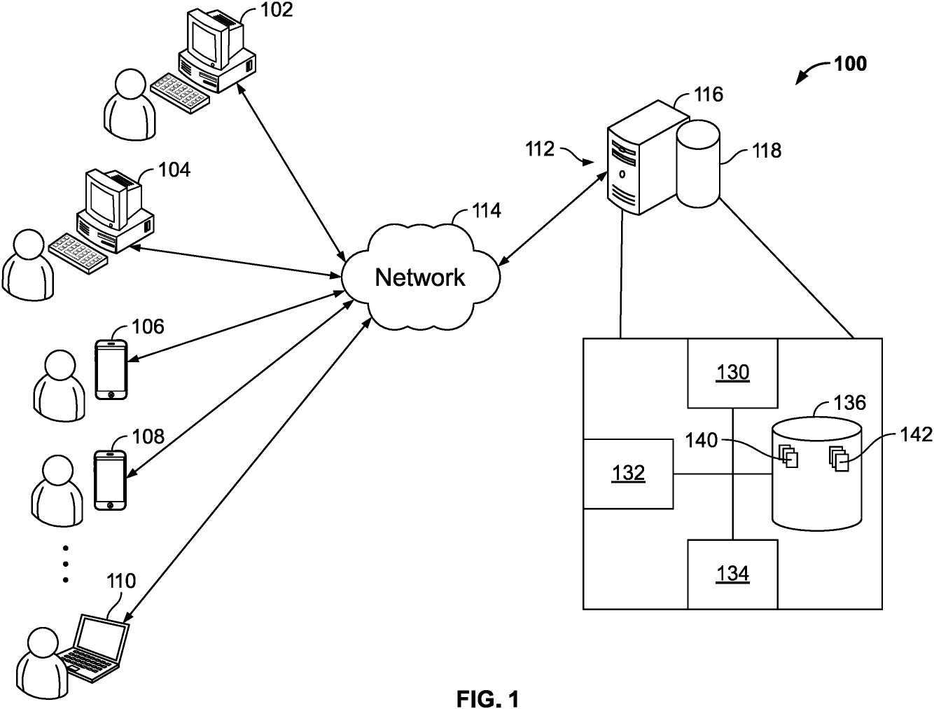

FIG. 1 illustrates an example distributed network architecture 100 that includes one or more client devices and one or more server devices that is operable to determine hydrocarbon well royalty valuations. The network architecture 100 includes a number of client devices 102, 104, 106, 108, 110 communicably connected to a structured data processing server system 112 (“server system 112”) by a network 114. The server system 112 includes a server device 116 and a data store 118. The server device 116 executes computer instructions (e.g., all or a part of a royalty valuation solver application) stored in the data store 118 to perform functions of a royalty valuation service. For example, in some aspects, the royalty valuation service may be a subscription service available to the client devices 102, 104, 106, 108, and 110 (and other client devices) by an owner or operator of the server system 112. In some aspects, the server system 112 may be owned or operated by a third party (e.g., a collocation server system) that hosts the royalty valuation service for the owner or operator of the royalty valuation service.

Generally, and as described in more detail herein, all or a part of the distributed network architecture 100 is operable to determine hydrocarbon well royalty valuations for royalties that are owned, all or partially, by a particular entity (such as a human owner or business entity). For example, the distributed network architecture 100 is operable to determine, based on one or more databases or data stores that include such information, a complete or substantially complete itemization of a royalty owner’s interests in or to multiple hydrocarbon producing wells (e.g., oil producing, gas producing, or both) based on, for example, information about a single hydrocarbon well from which the owner’s royalties arise. In some aspects, such information can be in the form of a royalty payment (e.g., a check or other payment instrument) or information typically found on a royalty payment (e.g., the owner, or payee, information; payor information; and otherwise). From this information, additional royalty interests of the owner (i.e., payee) can be determined and aggregated for presentation to the owner. In addition, the distributed network architecture 100 is operable to determine additional hydrocarbon wells that are unassociated with the particular owner but within a particular geographic area close to, adjacent, or accompanying another geographic area within which the owner does own royalty interests from one or more hydrocarbon wells. Thus, in some aspects, the distributed network architecture 100 is operable to propose additional hydrocarbon wells that produce royalties for evaluation and potential purchase by the owner.

Users of the client devices 102, 104, 106, 108, 110 access the server system 112 to participate in the royalty valuation service. For example, the client devices 102, 104, 106, 108, 110 can execute web browser applications that can be used to access the royalty valuation service. In another example, the client devices 102, 104, 106, 108, 110 can execute software applications that are specific to the royalty valuation service (e.g., as “apps” running on smartphones). In other words, all of the royalty valuation service may be hosted and executed on the server system 112. Or in alternative aspects, a portion of the royalty valuation service may execute on the client devices 102, 104, 106, 108, and 110 (e.g., to receive and transmit information entered by a user of such client devices and/or to display output data from the royalty valuation service to the user).

In some implementations, the client devices 102, 104, 106, 108, 110 can be provided as computing devices such as laptop or desktop computers, smartphones, personal digital assistants, portable media players, tablet computers, or other appropriate computing devices that can be used to communicate with an electronic social network. In some implementations, the server system 112 can be a single computing device such as a computer server. In some implementations, the server system 112 can represent more than one computing device working together to perform the actions of a server computer (e.g., cloud computing). In some implementations, the network 114 can be a public communication network (e.g., the Internet, cellular data network, dialup modems over a telephone network) or a private communications network (e.g., private LAN, leased lines).

As illustrated in FIG. 1, the server system 112 (e.g., the server device 116 and data store 118) includes one or more processing devices 132, a royalty valuation solver 130, one or more memory modules 136, and an interface 134. Generally, each of the components of the server system 112 are communicably coupled such that the one or more processing devices 132 may execute the royalty valuation solver 130 and access and manipulate data stored in the one or more memory modules 136. Data to be output from the server system 112, or data to be input to the server system 112, may be facilitated with the interface 134 that communicably couples the server system 112 to the network 114.

As illustrated in this example, the one or more memory modules 136 (e.g., or databases) may store or reference one or more data sets. An example data set includes royalty payment data 140. For example, royalty payment data 140 can include data associated with the payment of royalties from one or more payors (e.g., entities responsible for paying royalties to royalty interest owners) as well as data associated with the payment of royalties to one or more payees (e.g., royalty interest owners). Royalty payment data 140 can also include payment data itself, such as monetary amounts paid by the payor to the payee and hydrocarbon volumes (e.g., barrels of oil, cubic feet of natural gas) for which the payments are made, as well as data identifying the payment instrument (e.g., check number, routing number, check date, or a combination thereof). Royalty payment data 140 can also include identifying information on the hydrocarbon production wells from which the minerals (e.g., oil, gas, or both) are produced. The well identifying information can include, for instance, API well numbers, well names, lease names, or other information.

Another data set includes geographic data 142. For example, geographic data 142 can include hydrocarbon well identifiers associated with particular geographic parcels, e.g., the geo-specific location of wells within a defined area. In some aspects, the geographic parcels represent privately owned real property on which the wells are drilled (e.g., within one or more specific “lease” arrangements). In some aspects, the geographic parcels represent geo-political subdivisions of land, such as states, counties, townships, cities, or a combination thereof. Often, the geo-political subdivisions of land associated with hydrocarbon well leases are at a county-level geo-political division. The geographic data 142 can include well identifiers (e.g., API numbers) associated with specific geographic parcels of land (e.g., lease name, county name, or a combination thereof). In some aspects, royalty interest ownership information (e.g., payee data, payor data, or a combination thereof) can also be included in geographic date 142 or cross referenced with, for example, royalty payment data 140.

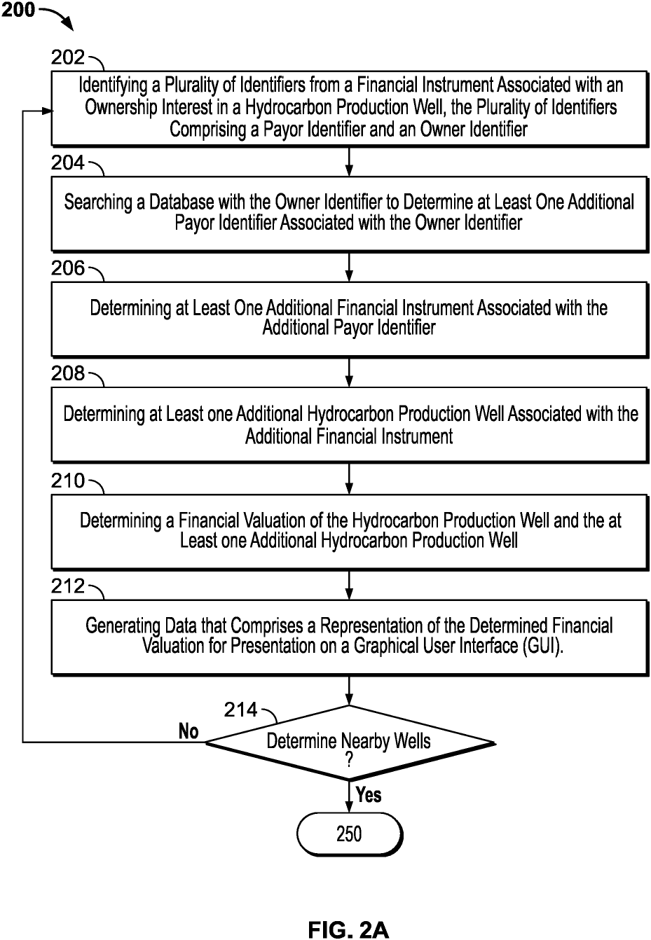

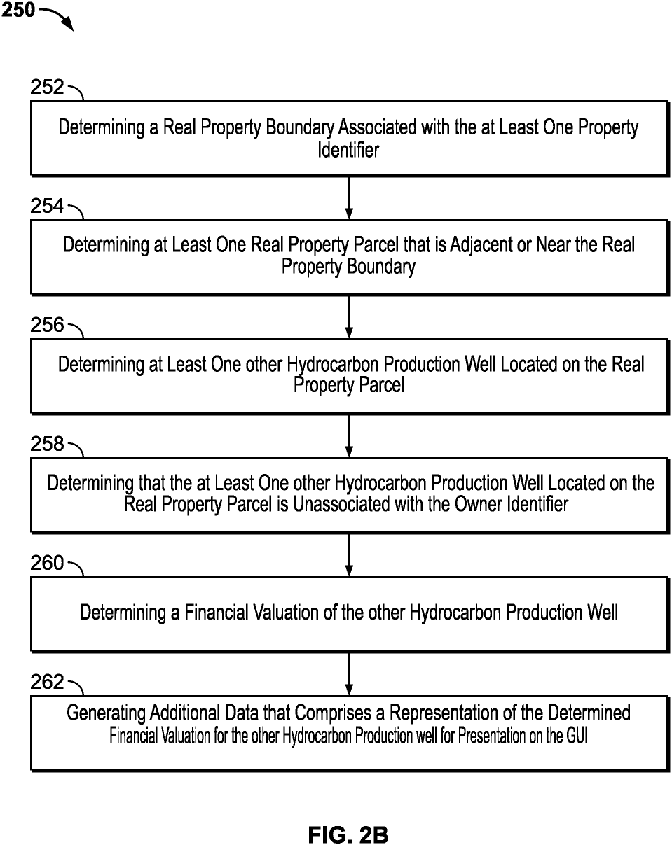

FIGS. 2A-2B illustrate flowcharts that show an example implementation of a method for determining hydrocarbon well royalty valuations according to the present disclosure. For example, FIG. 2A illustrates an example implementation of a method 200 for determining hydrocarbon well royalty valuations, while FIG. 2B illustrates an example implementation of a method 250 that can follow a decision in step 214 of method 200 shown in FIG. 2A. In some aspects, the example methods shown in FIGS. 2A-2B can be executed with or by the royalty valuation solver 130 shown in FIG. 1.

Method 200 can begin at step 202, which includes identifying a plurality of identifiers from a financial instrument associated with an ownership interest in a hydrocarbon production well, the plurality of identifiers comprising a payor identifier and an owner identifier. For example, in some aspects, payor or owner (payee) data can be determined according to, for instance, a payment document (such as a royalty payment instrument). A royalty payment document can be stored as royalty payment data 140 and include information such as payor information (typically a well operator or other entity that is responsible for facilitating payment of hydrocarbon royalties to an owner (e.g., identified by name or a unique number) of an interest in the hydrocarbons) and payee information (the owner of the interest). Other information from a royalty payment document can include instrument information (e.g., check number, check date, check amount) as identifiers. Other information from a royalty payment document can include an identification of the one or more hydrocarbon production wells in which the entity owns an interest, such as by API number, well name, lease name, or other identifying data.

In some aspects, the royalty payment instrument can be obtained, e.g., from the owner, such as through a scanned image of the instrument. Such information can be provided during step 202 (or before) by, for instance, a payee in response to a request for such information or otherwise. Of course, step 202 be iterated multiple times such that multiple ownership interests from multiple payees (or a single payee) can be identified or determined.

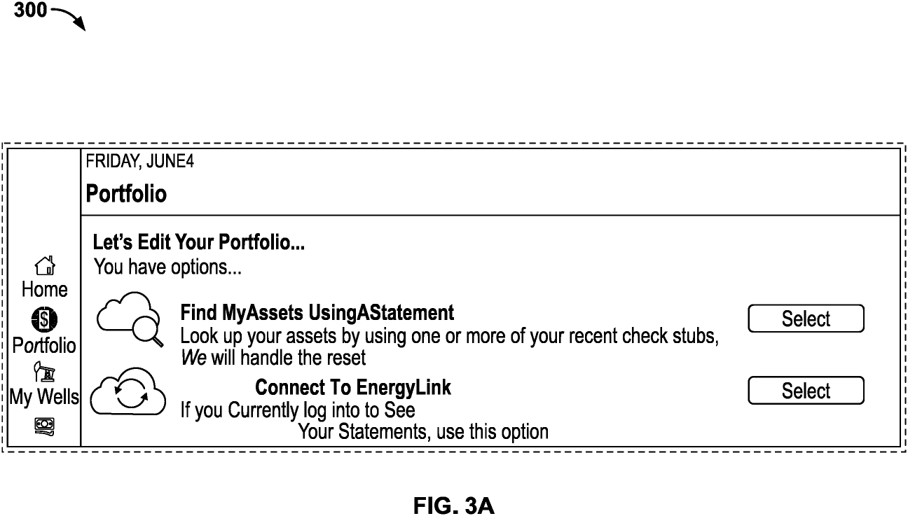

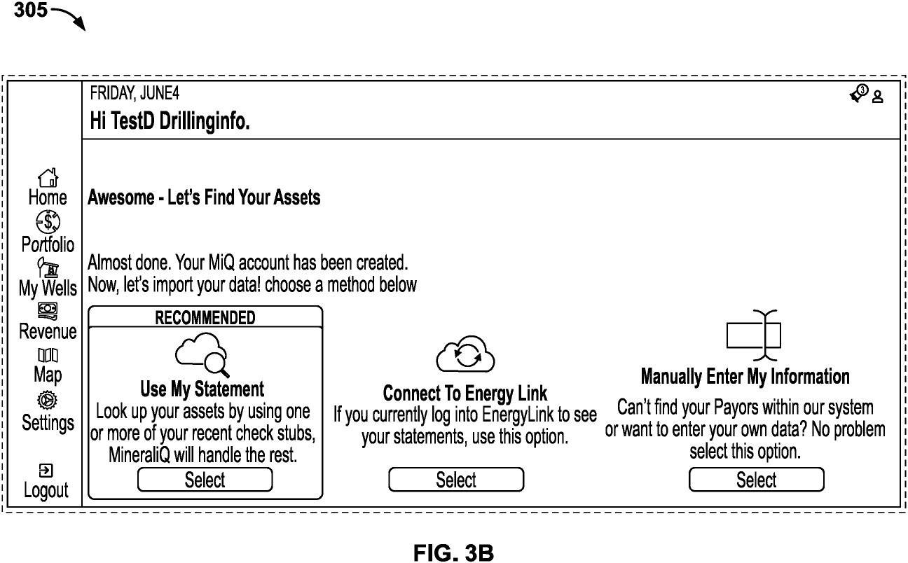

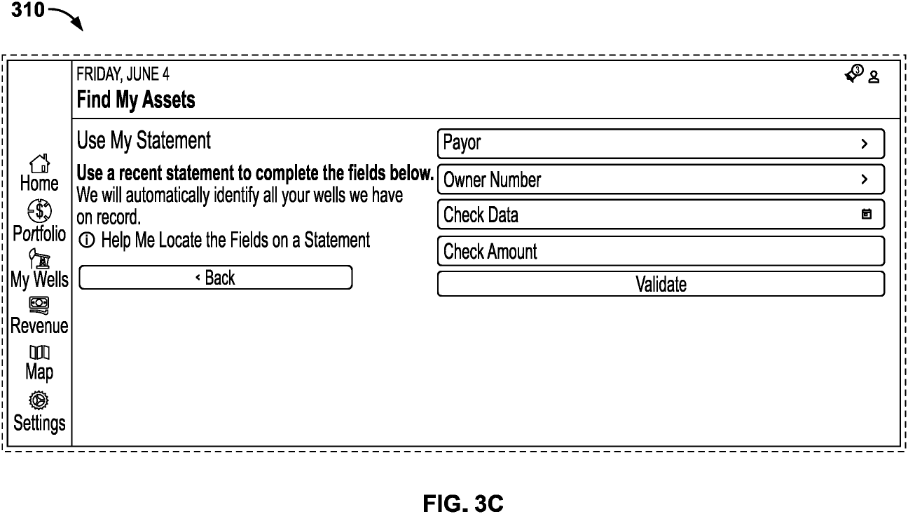

Turning briefly to FIGS. 3A-3C, these figures illustrate example GUI interfaces that can be implemented and presented, e.g., to the payee (or other entity) during or before step 202 of method 200. For example, a payee can begin or initiate method 200 by selecting an icon that allows the payee’s royalty ownership interests to be determined (and, if more than one, aggregated). For example, in GUI 300 in FIG. 3A, the payee can select “Find My Assets Using a Statement” to initiate the method 200. Next and turning to GUI 305 in FIG. 3B, the payee and select one of multiple techniques to present the plurality of identifiers from the financial instrument (e.g., a “statement” or “check stub” in this example. As shown in GUI 305, the payee can select either “Use My Statement” to move to GUI 310 in FIG. 3C or “Manually Enter My Information” where the payee can enter the plurality of identifiers through the GUI. In GUI 310, the payee can, e.g., expose an image of the statement through the GUI to the royalty valuation solver 130 shown in FIG. 1 (or enter information for the royalty valuation solver 130).

Turning back to FIG. 2A, method 200 can continue at step 204, which includes searching a database with the owner identifier to determine at least one additional payor identifier associated with the owner identifier. For example, a particular owner (payee) can be associated with one or multiple payor identifiers, e.g., for different hydrocarbon wells on the same or different well leases. Such information can be searched (e.g., by owner identifier) within the royalty payment data 140 to find other payor identifiers associated (e.g., through past or pending payments from a payor to the payee identified by the owner identifier) with the particular owner.

Method 200 can continue at step 206, which includes determining at least one additional financial instrument associated with the additional payor identifier. For example, once additional payor identifiers are identified, e.g., by the search from step 204, the additional financial instruments from the payor to the payee (e.g., other well operators that provide royalty payments to the owner) are identified (and can be aggregated and stored, at least transiently, in database 136).

Method 200 can continue at step 208, which includes determining at least one additional hydrocarbon production well associated with the additional financial instrument. For example, once the additional financial instruments are searched and located, well identifiers (such as API numbers) that are located or associated with the additional financial instruments can be identified (and can be aggregated and stored, at least transiently, in database 136). Thus, after step 208, the royalty valuation solver 130 has identified (by specific identifiers) all payors and wells through which the payee (i.e., royalty owner) is paid royalties for hydrocarbon production. Such identification of this information can be aggregated and stored, at least transiently, in database 136.

Method 200 can continue at step 210, which includes determining a financial valuation of the hydrocarbon production well and the at least one additional hydrocarbon production well. For example, the value of the payee’s royalty amounts for the hydrocarbon production well and the at least one additional hydrocarbon production well (e.g., aggregated) can be determined. If more than one additional hydrocarbon well is determined in step 208 (based on the additional financial instruments), all additional hydrocarbon well royalties can be aggregated along with the hydrocarbon production well’s royalty to determine, in step 210, a total royalty valuation for the payee’s royalties.

Method 200 can continue at step 212, which includes generating data that comprises a representation of the determined financial valuation for presentation on a graphical user interface (GUI). For example, as well as the determined financial valuation, other information or data determined in steps 202-208 can also be presented on a GUI to, e.g., the payee.

Method 200 can continue at step 214, which includes a decision as to determine (or not) whether nearby wells (e.g., one or more hydrocarbon producing wells near in distance to one or both of the hydrocarbon production well or the at least one additional hydrocarbon production well) exist. If the decision in step 214 is no, then method 200 can return to step 202.

If the decision in step 214 is yes, then method 250 can begin at step 252, which includes determining a real property boundary associated with the at least one property identifier. For example, the payee can, through method 250, determine if other producing hydrocarbon wells that are near to one or both of the hydrocarbon production well or the at least one additional hydrocarbon production well exist in order to make a decision as to whether or not to purchase royalty interests in the nearby wells. In some aspects, “near” can mean on the same production lease as one or both of the hydrocarbon production well or the at least one additional hydrocarbon production well. In some aspects, “near” can mean in the same geopolitical subdivision (e.g., county) as one or both of the hydrocarbon production well or the at least one additional hydrocarbon production well. In some aspects, “near” can mean on or adjacent the privately owned real property parcel as one or both of the hydrocarbon production well or the at least one additional hydrocarbon production well. In some aspects, “near” can mean within a certain distance of one or both of the hydrocarbon production well or the at least one additional hydrocarbon production well.

Method 250 can continue at step 254, which includes determining at least one real property parcel that is adjacent or near the real property boundary. For example, based on the search criteria for real property that is “near” the real property boundary associated with the at least one property identifier, one or more property units (e.g., leases, privately owned property units, geopolitical subdivisions) can be identified in step 254.

Method 250 can continue at step 256, which includes determining at least one other hydrocarbon production well located on the real property parcel. For example, once the at least one real property parcel is identified in step 254, hydrocarbon production wells (one or more) can be identified that are located on or within the identified real property parcel. The hydrocarbon production wells (one or more) can be identified by, for instance, a lease name or number, a county name, or other identifier associated with the real property parcel.

Method 250 can continue at step 258, which includes determining that the at least one other hydrocarbon production well located on the real property parcel is unassociated with the owner identifier. For example, in some aspects, step 258 can include excluding any hydrocarbon production well identified in step 256 that is already associated with the owner identifier from step 202, as such wells would be duplicates of those already identified, e.g., in step 208..

Method 250 can continue at step 260, which includes determining a financial valuation of the hydrocarbon production well. For example, as with step 210, the value of the royalty amounts for the hydrocarbon production well on the real property parcel can be determined. If more than one hydrocarbon production well on the real property parcel (or parcels) is determined in step 258, all hydrocarbon well royalties from such wells can be aggregated to determine, in step 260, a total royalty valuation for the hydrocarbon production wells on the real property parcel.

Method 250 can continue at step 262, which includes generating additional data that comprises a representation of the determined financial valuation for the other hydrocarbon production well for presentation on the GUI. For example, this additional financial valuation can be presented to the payee. With such information, the payee can make an informed decision on whether to purchase or attempt to purchase one or more royalty interest from hydrocarbon production wells that are near to those that the payee already owns an interest.

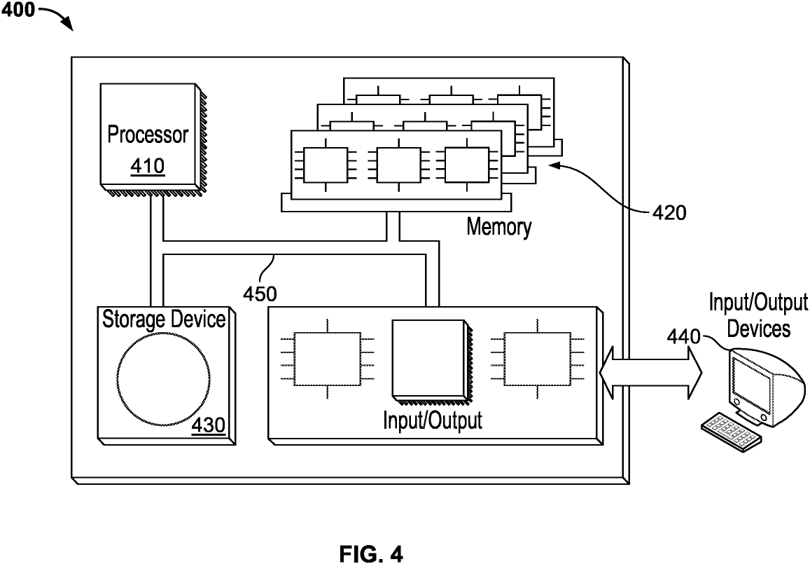

FIG. 4 is a schematic diagram of a computer system 400. The system 400 can be used for the operations described in association with any of the computer-implemented methods described previously, for example as or as part of the structured data processing server system 112 or other data processing systems described herein. The system 400 is intended to include various forms of digital computers, such as laptops, desktops, workstations, personal digital assistants, servers, blade servers, mainframes, and other appropriate computers. The system 400 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of embodiments have been described. Nevertheless, it will be understood that various modifications may be made without departing from the spirit and scope of what is described. For example, the steps of the exemplary flow charts in FIGS. 2A-2C may be performed in other orders, some steps may be removed, and other steps may be added. Accordingly, other embodiments are within the scope of the following claims.

1. A computer-implemented method performed with a computing system that comprises one or more hardware processors, comprising:
identifying, with the one or more hardware processors with an automated process, a plurality of identifiers from a financial instrument associated with an ownership interest in a hydrocarbon production well, the plurality of identifiers comprising a payor identifier and an owner identifier;
searching, with the one or more hardware processors with the automated process, a database with the owner identifier to determine at least one additional payor identifier associated with the owner identifier;
determining, with the one or more hardware processors with the automated process, at least one additional financial instrument associated with the additional payor identifier;
determining, with the one or more hardware processors with the automated process, at least one additional hydrocarbon production well associated with the additional financial instrument;
determining, with the one or more hardware processors with the automated process, a financial valuation of the hydrocarbon production well and the at least one additional hydrocarbon production well; and
generating, with the one or more hardware processors with the automated process, data that comprises a representation of the determined financial valuation for presentation on a graphical user interface (GUI).

2. The computer-implemented method of claim 1, wherein determining the additional hydrocarbon production well associated with the additional financial instruments comprises:
determining, with the one or more hardware processors, at least one property identifier associated with the additional financial instruments;
determining, with the one or more hardware processors, at least one hydrocarbon production well identifier associated with the at least one property identifier; and
determining, with the one or more hardware processors, the at least one additional hydrocarbon production well from the determined hydrocarbon production well identifier.

3. The computer-implemented method of claim 2, wherein the at least one property identifier comprises a hydrocarbon lease identifier, and the at least one hydrocarbon production well identifier comprises an API number.

4. The computer-implemented method of claim 2, further comprising:
determining, with the one or more hardware processors, a real property boundary associated with the at least one property identifier;
determining, with the one or more hardware processors, at least one real property parcel that is adjacent the real property boundary; and
determining, with the one or more hardware processors, at least one other hydrocarbon production well located on the real property parcel.

5. The computer-implemented method of claim 4, further comprising:
determining, with the one or more hardware processors, that the at least one other hydrocarbon production well located on the real property parcel is unassociated with the owner identifier;
determining, with the one or more hardware processors, a financial valuation of the other hydrocarbon production well; and
generating, with the one or more hardware processors, additional data that comprises a representation of the determined financial valuation for the other hydrocarbon production well for presentation on the GUI.

6. The computer-implemented method of claim 5, wherein the additional data further comprises at least one of
a hydrocarbon production well identifier for the other hydrocarbon production well; or
an owner identifier for the other hydrocarbon production well.

7. The computer-implemented method of claim 1, wherein the financial instrument comprises a royalty payment check.

8. The computer-implemented method of claim 7, wherein the plurality of identifiers further comprise a check number and a check amount.

9. The computer-implemented method of claim 1, wherein the owner identifier comprises a name or number associated with an owner of the ownership interest in the hydrocarbon production well.

10. The computer-implemented method of claim 1, wherein identifying the plurality of identifiers from the financial instrument associated with the ownership interest in the hydrocarbon production well comprises:
reading, with the one or more hardware processors, an image of the financial instrument; and
determining, with the one or more hardware processors, the plurality of identifiers from the image.

11. The computer-implemented method of claim 10, wherein the image comprises a scanned image.

12. A computing system, comprising:
one or more memory modules;
one or more hardware processors communicably coupled to the one or more memory modules, the one or more hardware processors configured to execute instructions stored on the one or more memory modules to perform operations within an automated process, comprising:
identifying a plurality of identifiers from a financial instrument associated with an ownership interest in a hydrocarbon production well, the plurality of identifiers comprising a payor identifier and an owner identifier;
searching a database with the owner identifier to determine at least one additional payor identifier associated with the owner identifier;
determining at least one additional financial instrument associated with the additional payor identifier;
determining at least one additional hydrocarbon production well associated with the additional financial instrument;
determining a financial valuation of the hydrocarbon production well and the at least one additional hydrocarbon production well; and
generating data that comprises a representation of the determined financial valuation for presentation on a graphical user interface (GUI).

13. The computing system of claim 12, wherein the operation of determining the additional hydrocarbon production well associated with the additional financial instruments comprises:
determining at least one property identifier associated with the additional financial instruments;
determining at least one hydrocarbon production well identifier associated with the at least one property identifier; and
determining the at least one additional hydrocarbon production well from the determined hydrocarbon production well identifier.

14. The computing system of claim 13, wherein the at least one property identifier comprises a hydrocarbon lease identifier, and the at least one hydrocarbon production well identifier comprises an API number.

15. The computing system of claim 13, wherein the operations further comprise:
determining a real property boundary associated with the at least one property identifier;
determining at least one real property parcel that is adjacent the real property boundary; and
determining at least one other hydrocarbon production well located on the real property parcel.

16. The computing system of claim 15, wherein the operations further comprise:
determining that the at least one other hydrocarbon production well located on the real property parcel is unassociated with the owner identifier;
determining a financial valuation of the other hydrocarbon production well; and
generating additional data that comprises a representation of the determined financial valuation for the other hydrocarbon production well for presentation on the GUI.

17. The computing system of claim 16, wherein the additional data further comprises at least one of:
a hydrocarbon production well identifier for the other hydrocarbon production well; or
an owner identifier for the other hydrocarbon production well.

18. The computing system of claim 12, wherein the financial instrument comprises a royalty payment check.

19. The computing system of claim 18, wherein the plurality of identifiers further comprise a check number and a check amount.

20. The computing system of claim 12, wherein the owner identifier comprises a name or number associated with an owner of the ownership interest in the hydrocarbon production well.

21. The computing system of claim 12, wherein the operation of identifying the plurality of identifiers from the financial instrument associated with the ownership interest in the hydrocarbon production well comprises:
reading an image of the financial instrument; and
determining the plurality of identifiers from the image.
